(19) United States
(12) Patent Application Publication
(10) Pub. No.: US 2026/0365527 A1
(43) Pub. Date: Nov. 19, 2026

(54) METHOD FOR PRODUCTION OF BLUE AMMONIA

(71) Applicant: TOPSOE A/S, Kgs. Lyngby (DK)

(72) Inventor: Per Juul DAHL, Vedbæk (DK)

(73) Assignee: TOPSOE A/S, Kgs. Lyngby (DK)

(21) Appl. No.: 19/148,394

(22) PCT Filed: Jan. 19, 2024
(86) PCT No.: PCT/EP2024/051259

§ 371 Date: Jul. 16, 2025

(30) Foreign Application Priority Data
Jan. 20, 2023 (DK) PA202300042

(51) Int. Cl. C01C 1/04; C01B 3/48

(52) U.S. Cl. CPC C01C 1/0405; C01B 3/48; C01B 2203/0205; C01B 2203/0283; C01B 2203/042; C01B 2203/047; C01B 2203/0475; C01B 2203/048; C01B 2203/0495; C01B 2203/068; C01B 2203/1235; C01B 2203/127; C01B 2203/148; C01B 2203/86

(57) ABSTRACT

The present invention provides a method and system for producing blue ammonia, providing for a high percentage of carbon capture. The method, device and plant of the invention may be used in any ammonia plant.

### FIELD OF INVENTION

The present invention provides a method, device and plant for producing blue ammonia, providing for a high percentage of carbon capture and nitrogen saving, when compared to prior art. The method and system of the invention may be used in any ammonia plant.

### BACKGROUND ART

Blue ammonia is a fossil fuel-based product produced with minimum emission of CO₂ to the atmosphere. It is seen as a transition product between conventional fossil fuel-based ammonia and green ammonia produced from green or renewable power and air. The CO₂ resulting from a blue ammonia production shall be stored permanently or converted into other chemicals. The main steps for producing blue ammonia are essentially the same as for producing conventional fossil fuel-based ammonia, the difference being that more of the carbon stemming from the carbon fuel is captured, providing a possibility for further processing.

The key here is that the blue ammonia does not release any carbon dioxide when used as fertilizer or burned. Currently available technology traps nearly all CO₂ generated during the conversion process making this fuel one of the first carbon free fuel options for mass use. Blue ammonia is considered an environmental friendly product which can be used until sufficient renewable or green power is available for producing green ammonia.

If we can continue to diversify our power generation methods and create more and more renewable or green energy, the potential rises that we can perfect a method of green energy that produces hydrogen and ammonia as byproducts giving us a completely clean and safe power cycle.

Document WO2018/149641 discloses a process for the synthesis of ammonia from natural gas comprising conversion of a charge of desulphurized natural gas and steam, with oxygen-enriched air or oxygen, into a synthesis gas (11), and treatment of the synthesis gas (11) with shift reaction and decarbonation, wherein a part of the CO₂-depleted synthesis gas, obtained after decarbonation, is separated and used as fuel fraction for one or more furnaces of the conversion section, and the remaining part of the gas is used to produce ammonia.

WO 2022/228839 is different from the setup disclosed in WO2018/149641 in that it allows for the recovery of a flash gas from the CO₂ removal step and enables the use of a more carbon depleted fuel, thereby achieving a higher carbon recovery (more than 99%).

The present invention provides a method for producing blue ammonia wherein the required final nitrogen addition is performed in a mixing device reducing the nitrogen flow and resulting in two streams with different composition and function. The first stream will be used as fuel and the second for ammonia synthesis. The mixing device is shown in FIG. 4.

### SUMMARY OF INVENTION

The present invention refers to a method, device and plant for producing ammonia, in particular blue ammonia, with a high percentage of carbon capture, preferably >99% of carbon capture, when compared to the standard method where optimally between about 90-93% of carbon capture is achieved.

The method of the present invention provides for the following advantages:
Can be applied for grass root plants and as revamps
Utilize the already available CO₂ removal step in the ammonia process to perform the complete CO₂ capture;
Enables >99% CO2 recovery;
Enables nitrogen saving;
Reduces the adiabatic flame temperature thus reducing the NOx formations and thereby the NOx emission to the atmosphere;

Said advantages are provided by a set of features, comprising:
Natural gas firing is reduced to be used for pilot burners;
Carbon depleted gases mainly H₂ and N₂ used as fuel for the fuel systems;
Mixing device, shown in FIG. 4, arranged such that the syngas stream A is mixed with a nitrogen stream B in order to extract a fuel stream C and an ammonia syngas stream D, wherein the composition of said four streams are different at all times;
Off-gases containing more than 60% Methane and/or CO are redirected to the reforming section or to the desulfurization section as additional feed gas;

### BRIEF DESCRIPTION OF DRAWINGS

FIG. 1 shows an overview for producing ammonia according to a state of the art method.
a) Desulphurization
b₀) Pre-reforming
b) Reforming (SMR)
b) Secondary reformer (air blown ATR)
c) Shift section
d) CO₂ removal section
e) Methanation
f) Ammonia synthesis
g) Fuel system(s)
h) Off gas recycle compressor
i) Ammonia recovery
Stream (10). Recycle off-gas stream
Stream (9). Hydrogen rich fuel comprising nitrogen (replacing use of natural gas as fuel)
Stream (2) Flash gas from CO2 removal

FIG. 2 shows an overview of a method to produce Ammonia using Topsoe SynCOR Ammonia™ process″:
a) Desulphurization
b₀) Pre-reforming
b) Reforming (ATR)
c) Shift section
d) CO2 Removal
e) Nitrogen wash or PSA
f) Ammonia synthesis
h) Off gas recycle compressor
g) Fuel system(s)
Stream (4,8). Recycle off-gas stream.
Stream (5,7). Hydrogen rich fuel comprising nitrogen (replacing use of natural gas as fuel)
Stream 2. Flash gas from CO2 removal

FIG. 3 shows an overview for producing ammonia using a steam reformer followed by an autothermal reformer in the synthesis gas generation:
a) Desulphurization
b0) Pre-reforming
b) Reforming (SMR)
b) Reforming (ATR)
c) Shift section
d) CO₂ removal
e) Nitrogen wash or PSA
f) Ammonia synthesis
h) Off gas recycle compressor
g) Fuel system(s)
Stream (4,8). Recycle off-gas stream.
Stream (5,7). Hydrogen rich fuel comprising nitrogen (replacing use of natural gas as fuel) Stream (2). Flash gas from CO₂ removal

References used to represent the different steps of in the method and plant of the prior art (FIGS. 1, 2 and 3) are:
a) Desulphurization
b₀) Pre-reforming
b) Reforming (SMR)
b) Reforming (ATR)
b) Reforming (Air blown secondary reformer)
c) Shift
d) CO₂ Removal
e) Nitrogen wash or PSA or Methanation
f) Ammonia synthesis
g) Fuel system(s)
h) Off gas recycle compression
i) Ammonia recovery
Stream (4,8,10): Recycle off-gas stream.
Stream (9): Hydrogen rich fuel (replacing use of natural gas as fuel)
Stream (5,7): Hydrogen rich fuel (replacing use of natural gas as fuel)
Stream (2): Flash gas from CO₂ removal

FIG. 4 shows the mixing device of the present invention. Stream A is mixed with stream B achieving outlet stream C and D, where A, B, C and D have different composition and function. Stream A achieves a different composition from C and D due to the mixing with B. C and D achieve different composition between them due to the inherent partial mixing arrangement of stream B. These differences will occur for any flow of (A, B, C, D)>0. The partial mixing arrangement is fixed by the distances L and M, combined with the number of inlets or holes N1 and N2 within these distances. Due to the asymmetrical outlet of stream C the average composition obtained through view E will be different from the average composition obtained through view F. It will therefore not be possible to extract two identical streams from this special piping element for L and M>0.1 m and N1, N2>0.

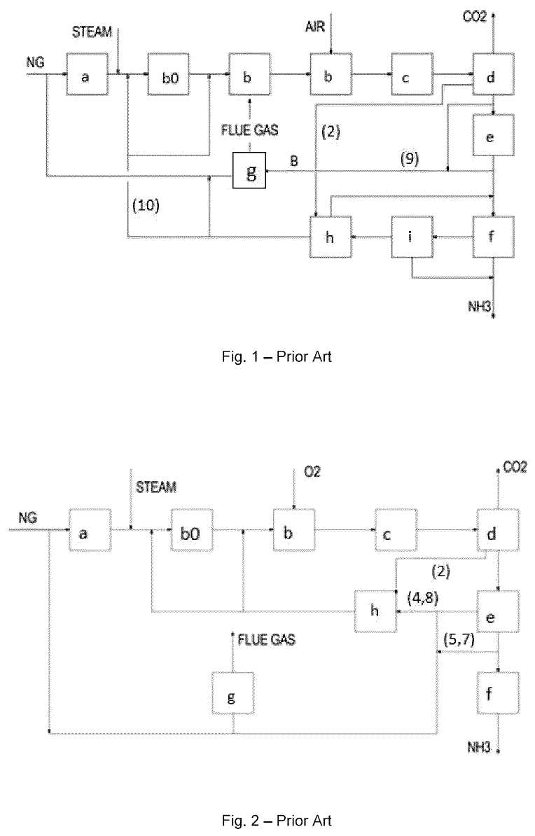

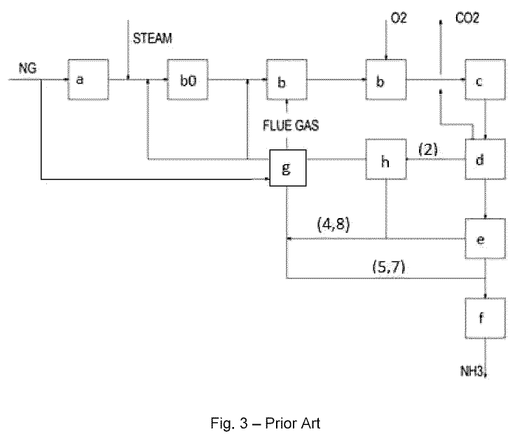

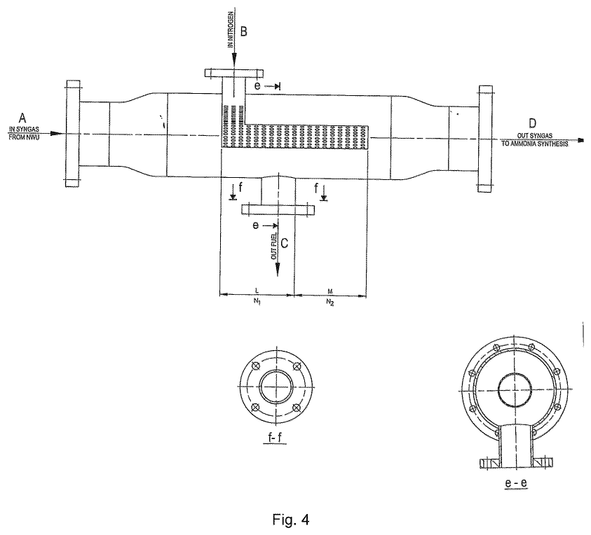

References used to represent the different steps of in the method and plant of the present invention (FIG. 4) are:
a) a desulfurization unit;
b) a reforming unit;
c) a shift unit
d) a CO2 removal unit;
e) a nitrogen washing unit or a pressure swing adsorption unit or a methanation unit,
f) a mixing device according to claims 11 and 12;
g) an ammonia synthesis section; and
h) fuel systems,

### DEFINITIONS

Blue Ammonia is ammonia that is created from using fossil fuel where at least 90% of the Carbon in the fossil fuel is captured to be used in other products and processes or to be stored.

Catalyst poison means a substance that reduces the effectiveness of a catalyst in a chemical reaction. In theory, because catalysts are not consumed in chemical reactions, they can be used repeatedly over an indefinite period of time. In practice, however, poisons, which come from the reacting substances or products of the reaction itself, accumulate on the surface of solid catalysts and cause their effectiveness to decrease. For this reason, when the effectiveness of a catalyst has reached a certain low level, steps are taken to remove the poison or replenish the active catalyst component that may have reacted with the poison. Commonly encountered poisons include carbon on the silica-alumina catalyst in the cracking of petroleum; sulfur, arsenic, or lead on metal catalysts in hydrogenation or dehydrogenation reactions; and oxygen and water on iron catalysts used in ammonia synthesis.

Contaminant means any substances or elements which are not desirable. Within the context of the present invention, contaminants comprise catalyst poisons.

Flash gas means an intermediate gas stream obtained during desorption of CO₂ in a solvent based CO₂ removal step.

Green Ammonia is ammonia that is produced by using green electricity, water and air.

Green Electricity is electricity produced from renewable resources such as wind, solar, Hydro or geothermal energy

Ammonia synthesis catalysts mean, within the context of the present invention, any catalysts suitable for synthesizing ammonia and also suitable for cracking ammonia. These catalysts are preferably iron (Fe) based, but may also comprise other catalysts suitable for the same purpose and operating at similar conditions.

Electrolysis of water means decomposition of water into oxygen and hydrogen gas due to the passage of an electric current.

Fuel systems comprise fuel systems for supply of fuel to the combustion side of tubular reformers and/or fired heaters and/or auxiliary boilers and/or gas turbines. These systems comprise one or more burners in which the incoming fuel streams are burned together with air at variable temperature and pressure.

High-pressure electrolysis (HPE) is the electrolysis of water by decomposition of water (H₂O) into oxygen (O₂) and hydrogen gas (H₂) due to the passing of an electric current through the water at elevated pressure, typically above 10 bar.

Make-up ammonia or Traded Ammonia comprises ammonia (NH₃) and water (H₂O), preferably between 0.2 to 0.5% of water content. It is usually supplied as a liquid but may also be a solution comprising different physical states. The effect of water comprised in ammonia feedstock in the ammonia decomposition process is primarily that due to poisoning the process, which usually has to take place at a high temperatures. This will increase process cost for ammonia decomposition as well as cost of construction materials in the plant. According to National Bureau of Standards ammonia shall conform to the following properties: minimum purity of 99.98% (wt), maximum 0.0005% (wt) oil and maximum 0.02% (wt) moisture.

Nitridation means the formation of nitrogen compounds through the action of ammonia.

PSA means pressure swing adsorption.

Shift means Water-gas shift reaction (WGSR) or Shift reaction, the reaction of carbon monoxide and water vapor to form carbon dioxide and hydrogen:

CO+H₂O⇄CO₂+H₂

The WGSR is an important industrial reaction that is used in the manufacture of ammonia, hydrocarbons, methanol, and hydrogen. It is also often used in conjunction with steam reforming of methane and other hydrocarbons. In the Fischer-Tropsch process, the WGSR is one of the most important reactions used to balance the H₂/CO ratio. The water gas shift reaction is a moderately exothermic reversible reaction. Therefore, with increasing temperature the reaction rate increases but the carbon dioxide production becomes less favorable. Due to its exothermic nature, high carbon monoxide percentage is thermodynamically favored at low temperatures. Despite the thermodynamic favorability at low temperatures, the reaction is faster at high temperatures.

Shift unit or section means a process step where the shift reaction is performed.

Mixing device means a device, preferably L-shaped, suitable for mixing two or more gas streams with different composition into two or more new gas streams with different composition, said device displaying one or more inlets or holes which allow for the contact and mixing of said two or more gas streams and extraction of said two or more new gas streams.

### DESCRIPTION OF THE INVENTION

Reducing CO₂ emission has become a bound task in the chemical industry. Production of ammonia using hydrocarbons as feedstock inevitably results in CO₂ formation which typically ends up in at least two CO₂ containing process streams, one almost pure CO₂ stream (1) extracted from the syngas cleaning section and one or more flue gas streams (2). The CO₂ stream (1) can be utilized for further chemical processing or stored. The CO₂ in the flue gas stream (2) needs to be recovered before it can find similar use. The flue gas recovery process has a high operating and capital cost. It is therefore an advantage to limit the CO₂ content in the flue gas.

It is well known that CO₂ in the flue gas can be avoided by using carbon free fuels. In general hydrocarbons such as natural gas and carbon containing off gases originating from the process are used as fuels.

The present invention refers to a method, device and plant for producing ammonia, in particular blue ammonia, with a high percentage of carbon capture, preferably >99% of carbon capture, when compared to the standard method where optimally between about 90-93% of carbon capture is achieved.

A method, device and plant are provided where mixing of a syngas stream A and a nitrogen rich stream B is achieved in such way that a fuel stream C and a syngas for ammonia synthesis stream D are obtained and the composition and function of these four streams A, B, C and D is different at all times. This allows for an more efficient production of blue ammonia while less nitrogen is used, when compared to the prior art.

### PREFERRED EMBODIMENTS

1. Process for producing ammonia comprising the steps of:
a) Removing sulphur and other contaminants from a hydrocarbon feed;
b) Reforming the hydrocarbon stream from step a) and obtaining synthesis gas comprising CO, CO₂, H₂, H₂O and CH₄;
c) Sending the gas from step b) through a shift reaction step reducing the CO content;
d) Sending the gas from step c) to a CO₂ removal step where it is split in at least 2 streams: a CO₂ rich stream; and a hydrogen rich stream;
e) Sending the hydrogen rich stream from step d) through:
i) hydrogen purification and nitrogen wash, where H₂O, CO, CO₂, CH₄ are removed in an off-gas stream and N₂ is added to obtain a synthesis gas stream and a fuel stream comprising N₂ and H₂; or
ii) a PSA, resulting in a hydrogen stream containing more than 99.5% hydrogen to which nitrogen is added to obtain a synthesis gas stream and a fuel stream comprising N₂ and H₂ and an off-gas stream;
f) Sending the synthesis gas stream from step e) through an ammonia synthesis section, where it is converted to NH₃ and the fuel stream is sent to the fuel systems,
wherein nitrogen (B) in step e i) and ii) is added in a mixing device obtaining two streams with different composition and function: i) a synthesis gas stream for ammonia synthesis (D) and ii) a fuel stream (C).

After step e) a methane-rich fuel stream comprising at least CH4, CO, and O2 is directed to fuel systems while the purified CO2-depleted stream (A) is methane-depleted and comprises N2 and a high concentration of H2.

The step of splitting the purified CO2-depleted stream (A) into a first stream (C) and a second stream (D) is via the mixing device of the present invention.

The purified CO2 depleted stream (e.g., stream A) is split to generate a first stream (e.g., fuel fraction C) and a second stream (e.g., process gas D). Preferably, a gradual addition of nitrogen via a perforated L-shaped pipe ensures a nitrogen-light first stream (C) and a nitrogen-rich second stream (D). Significantly, as explained herein, the first stream (C) is produced only from a bottom section of the main pipe such that its split will never result in first and second streams with the same composition.

2. Process according to embodiment 1 wherein in step d) the gas from step c) is sent to a CO₂ removal step where it is split in at least 3 streams: a CO₂ rich stream, a flash gas and a hydrogen rich stream, wherein the flash gas is compressed together with streams (4,8,10) and sent to step a) or b).

3. Process according to any one of the preceding embodiments wherein a synthesis gas stream (D) and a fuel stream (C)) comprise different amounts of N₂ and H₂.

4. Process according to any one of the preceding embodiments wherein a hydrocarbon fuel, flash gas (2) from step d), off-gas (4,8) from step e) and fuel stream (C) from step e) are either premixed or fed separately to the fuel systems g).

5. Process according to any one of the preceding embodiments comprising an adiabatic pre-reforming step b₀) of the hydrocarbon stream from step a), before step b), wherein a synthesis gas comprising CH₄, CO, CO₂, H₂ and H₂O is obtained.

6. Process according to any one of the preceding embodiments, wherein the amount of air to the air blown secondary reformer is adjusted to obtain a specific ratio of N₂ and H₂ between 1 to 2.5 and 1 to 3.5, in the stream from the methanation reactor.

7. Process according to embodiment 6 wherein the stream obtained from step e) comprises N₂ and H₂ in a ratio of 1 to 3.0.

8. Process according to any one of the previous embodiments wherein at least part of the off-gas (4,8) removed in step e) i) and e) ii) are compressed and sent to step a) or b).

9. Process according to any one of the previous embodiments wherein said hydrogen rich stream from step d) undergoes methanation, converting the CO and CO2 together with H2 into CH4 and H2O, to obtain a synthesis gas stream, N2, H2 and inerts comprising CH4.

10. Process according to the previous embodiment wherein at least part of recovered CH₄ (10) stemming from synthesis gas is compressed and sent to step a) or b).

11. Mixing device (FIG. 4) for mixing two gas streams, A and B, with different composition into two new gas streams, C and D, with different composition and function, wherein said device comprises one or more, preferably multiple, inlets distributed across its surface and said inlets provide a means for contacting and mixing streams A and B as well as a means for extracting streams C and D.

The arrangement in the present invention comprises a main pipe where the purified CO₂-depleted stream (A) is introduced, and a perforated, preferably L-shaped, mixing device where a nitrogen stream (B) is introduced. Preferably, a main pipe concentrically surrounds the perforated extension of the mixing device, e.g. an L-shaped pipe.

12. Mixing device according to embodiment 11, wherein said device is an L-shaped tube.

13. Plant for producing ammonia according to the process in embodiments 1 to 10, comprising:
a) a desulfurization unit;
b) a reforming unit;
c) a shift unit
d) a CO₂ removal unit;
e) a nitrogen washing unit or a pressure swing adsorption unit or a methanation unit,
f) a mixing device according to embodiments 11 and 12;
g) an ammonia synthesis section; and
h) fuel systems,
arranged such that the addition of nitrogen stream, B, to stream A is performed in said mixing device f) obtaining two streams with different composition and function, a synthesis gas stream for ammonia synthesis D and a fuel stream C.

14. Plant according to embodiment 13 wherein streams (4,8,10) are directed to desulfurization unit a) and/or to reforming unit b).

15. Plant for producing ammonia according to any one of embodiments 13 to 14, wherein the carbon content in the combined flue gases from the fuel systems h) is less than 5%, preferably less than 1% of the combined carbon content in the hydrocarbon feed and the hydrocarbon fuel.

16. Plant according to any one of embodiments 13 to 15 wherein a further pre-reforming unit b₀) is upstream to the reforming unit b).

17. 4. Plant according to any one of embodiments 13 to 16 10 to 13 wherein the shift unit c) comprises a high temperature (HT) reactor or a medium temperature (MT) reactor or a low temperature (LT) reactor or any combination of at least two of these.

18. Plant according to any one of embodiments 13 to 17 wherein the fuel systems h) comprise tubular reformers, fired heaters, auxiliary boilers and gas turbines.

19. Plant according to embodiment 18, wherein the fuel systems h) comprise one or more burners.

20. Use of CO₂ obtained in step d) of embodiment 1 for CO₂ storage.

21. Use of CO₂ obtained in step d) of embodiment 1 to produce chemicals, such as urea or other suitable chemical.

### Example

Compositions of streams A, B, C and D assessed in a specific instant within the mixing device.

| | | Composition | |
|---|---|---|---|
| Stream | Designation | Hydrogen (mol %) | Nitrogen (mol %) |
| A | Syngas | 23 | 77 |
| B | Nitrogen | 0 | 100 |
| C | Fuel | 24 | 76 |
| D | Syngas | 25 | 75 |

1. Process for producing ammonia comprising the steps of:
a) removing sulphur and other contaminants from a hydrocarbon feed;
b) reforming the hydrocarbon stream from step a) and obtaining synthesis gas comprising CO, CO₂, H₂, H₂O and CH₄;
c) sending the gas from step b) through a shift reaction step reducing the CO content;
d) sending the gas from step c) to a CO₂ removal step where it is split in at least 2 streams: a CO₂ rich stream; and a hydrogen rich stream;
e) sending the hydrogen rich stream from step d) through:
i) hydrogen purification and nitrogen wash, where H₂O, CO, CO₂, CH₄ are removed in an off-gas stream and N₂ is added to obtain a synthesis gas stream and a fuel stream comprising N₂ and H₂; or
ii) a PSA, resulting in a hydrogen stream containing more than 99.5% hydrogen to which nitrogen is added to obtain a synthesis gas stream and a fuel stream comprising N₂ and H₂ and an off-gas stream;
f) sending the synthesis gas stream from step e) through an ammonia synthesis section, where it is converted to NH₃ and the fuel stream is sent to the fuel systems,
wherein nitrogen in step e i) and ii) is added in a mixing device obtaining two streams with different composition and function: i) a synthesis gas stream for ammonia synthesis and ii) a fuel stream.

2. The process according to claim 1, wherein a synthesis gas stream and the fuel stream comprise different amounts of N₂ and H₂.

3. The process according to claim 1, wherein a hydrocarbon fuel, flash gas from step d), off-gas from step e) and the fuel stream from step e) are either premixed or fed separately to the fuel systems g).

4. The process according to claim 1, wherein at least part of the off-gas removed in step e) i) and e) ii) are compressed and sent to step a) or b).

5. The process according to claim 1, wherein said hydrogen rich stream from step d) undergoes methanation, converting the CO and CO₂ together with H₂ into CH₄ and H₂O, to obtain a synthesis gas stream, N₂, H₂ and inerts comprising CH₄.

6. The process according to claim 5, wherein at least part of recovered CH₄ stemming from synthesis gas is compressed and sent to step a) or b).

7. Mixing device for mixing two gas streams, A and B, with different composition into two new gas streams, C and D, with different composition and function, wherein said device comprises one or more inlets distributed across its surface and said inlets provide a means for contacting and mixing streams A and B and a means for extracting streams C and D.

8. The mixing device according to claim 7, wherein said mixing device is an L-shaped tube.

9. Plant for producing ammonia according to the process in claim 1, comprising:
a) a desulfurization unit;
b) a reforming unit;
c) a shift unit
d) a CO₂ removal unit;
e) a nitrogen washing unit or a pressure swing adsorption unit or a methanation unit,
f) a mixing device for mixing two gas streams, A and B, with different composition into two new gas streams, C and D, with different composition and function, wherein said device comprises one or more inlets distributed across its surface and said inlets provide a means for contacting and mixing streams A and B and a means for extracting streams C and D;
g) an ammonia synthesis section; and
h) fuel systems,
arranged such that the addition of nitrogen stream, B, to stream A is performed in said mixing device f) obtaining two streams with different composition and function, a synthesis gas stream for ammonia synthesis D and a fuel stream C.

10. The plant for producing ammonia according to claim 9, wherein the carbon content in the combined flue gases from the fuel systems h) is less than 5%, of the combined carbon content in the hydrocarbon feed and the hydrocarbon fuel.

11. The plant according to claim 9, wherein a further pre-reforming unit b₀) is upstream to the reforming unit b).

12. The plant according to claim 9, wherein the fuel systems h) comprise tubular reformers, fired heaters, auxiliary boilers and gas turbines.

13. A method comprising using CO₂ obtained in step d) of claim 1 for CO₂ storage.

14. A method comprising using CO₂ obtained in step d) of claim 1 to produce chemicals.
